(19) United States
(12) Patent Application Publication
(10) Pub. No.: US 2016/0099021 A1
(43) Pub. Date: Apr. 7, 2016

(54) MULTI-SPEED PROGRAMMABLE BATCH SCRUBBER SYSTEM

(71) Applicant: WD Media, LLC, San Jose, CA (US)

(72) Inventors: CHENG SEE LIM, PENANG (MY); KOK FUAT LEE, PENANG (MY)

(21) Appl. No.: 14/508,837

(22) Filed: Oct. 7, 2014

(51) Int. Cl. G11B 23/50

(52) U.S. Cl. CPC G11B 23/505

(57) ABSTRACT

Systems and methods for a multi-speed programmable batch scrubber are illustrated. The disclosed system includes a brush configured to scrub a disk at a plurality of speeds during cleaning of the disk, a combing system configured to support the disk during cleaning, a cleaning solution dispenser, and a first deionized water dispenser configured to dispense water on the brush during cleaning. The disk is cleaned in a plurality of predetermined cleaning steps, each step including predetermined parameter values such as the brush RPM, the step duration, the dispensing state of the cleaning solution dispenser, and the dispensing state of the deionized water dispenser.

### BACKGROUND

Magnetic media disks used in hard disk drives include a substrate that is plated with a material such as nickel. After plating, the disks are subsequently polished using a process such as chemical mechanical polishing. During this polishing process, The surfaces of the disks may be exposed to contamination from the polish slurry, the polish residue, the manufacturing equipment, and/or the manufacturing environment. In particular, the polish slurry has a tendency to bond to the surface of the disks making contamination particles from the slurry difficult to remove.

A disk batch scrubbing process is used to remove these surface contaminants by employing a plurality of brushes to scrub multiple disk surfaces simultaneously while applying a cleaning solution and deionized water. This disk batch scrubbing process is particularly important for cleaning magnetic media disks as it is the most effective way to remove contamination particles by the application of mechanical force. If contamination particles are not sufficiently removed from the surface of the polished disk, the operation and performance of a hard drive incorporating the disk will suffer.

FIG. 1 illustrates a conventional method 100 of cleaning a polished magnetic media that is implemented in conventional batch scrubber systems. At operation 101, a scrubbing brush is rotated up to a fixed rotation speed in revolutions per minute (RPM) that is maintained during cleaning operation 102-103. At operation 102, the disk is scrubbed by the brush with a cleaning solution for a first period of time. At operation 103, the disk is scrubbed by the brush with deionized water for a second period of time, thereby completing the cleaning process. Table 1, below, summarizes this conventional method.

TABLE 1
Conventional Batch Scrubbing Method

| | | DURATION |
|---|---|---|
| OPERATION | BRUSH SPEED (RPM) | (seconds) |
| Cleaning Solution Scrub | FIXED | T₁ |
| Deionized Water Scrub | | T₂ |

The conventional process, while removing some defects, creates new scratches and leaves behind several defects. Further, the conventional process lacks configurability. Particularly, the conventional cleaning process does not allow variation in the brush RPM when the brush is engaged or disengaged to the disk.

Accordingly, improved methods and systems for batch cleaning polished plated disk are desirable.

### BRIEF DESCRIPTION OF THE DRAWINGS

The present application is illustrated by way of example, and not limitation, in the figures of the accompanying drawings in which:

FIG. 1 is an operational flow diagram illustrating a conventional method of cleaning a polished magnetic media disk.

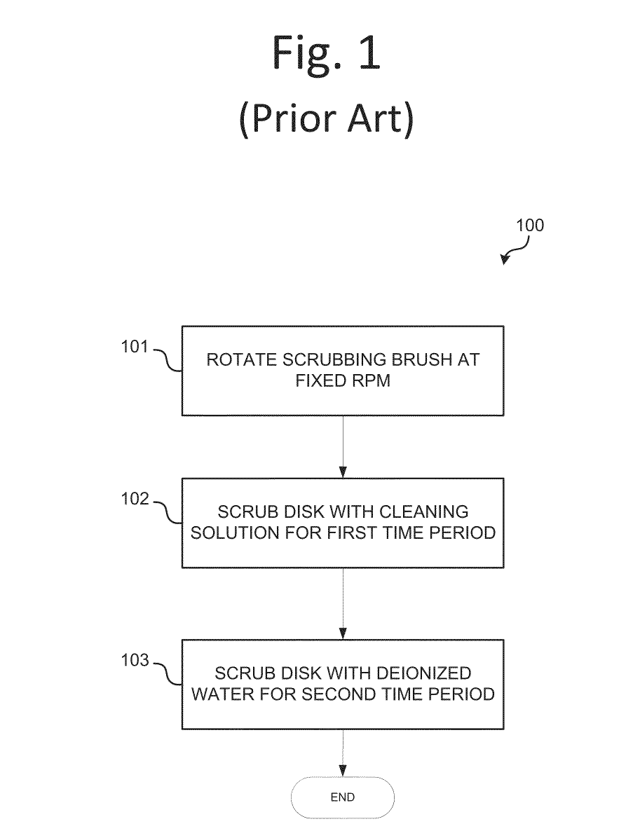

FIG. 2A is a schematic diagram of an exemplary batch scrubber system in accordance with an embodiment of the present disclosure.

FIG. 2B is a high-level block diagram illustrating a batch processing user computer that may be used in the system of FIG. 2B.

FIG. 3 is an operational flow diagram illustrating an exemplary method for cleaning one more polished magnetic media disks that may be implemented with the batch scrubber system of FIGS. 2A-2B.

FIG. 4 is a chart illustrating differences in cleaned disk defect counts between conventional batch scrubber systems and the batch scrubber systems disclosed herein.

FIG. 5 illustrates an example computing module that may be used to implement various features of the system and methods disclosed herein.

### DETAILED DESCRIPTION

In the following description, numerous specific details are set forth to provide a thorough understanding of various embodiment of the present disclosure. It will be apparent to one skilled in the art, however, that these specific details need not be employed to practice various embodiments of the present disclosure. In other instances, well known components or methods have not been described in detail to avoid unnecessarily obscuring various embodiments of the present disclosure.

In accordance with the present disclosure, systems and methods for implementing a multi-speed programmable batch scrubber are disclosed. The multi-speed programmable batch scrubber system provides several benefits over conventional batch scrubbers. First, the configurability of the batch scrubber cleaning process allows optimization of every cleaning operation, thereby batch cleaning the magnetic media faster and removing a greater number of surface particle defects. Second, the disclosed batch scrubber system and method results in fewer surface scratches than the conventional system and method.

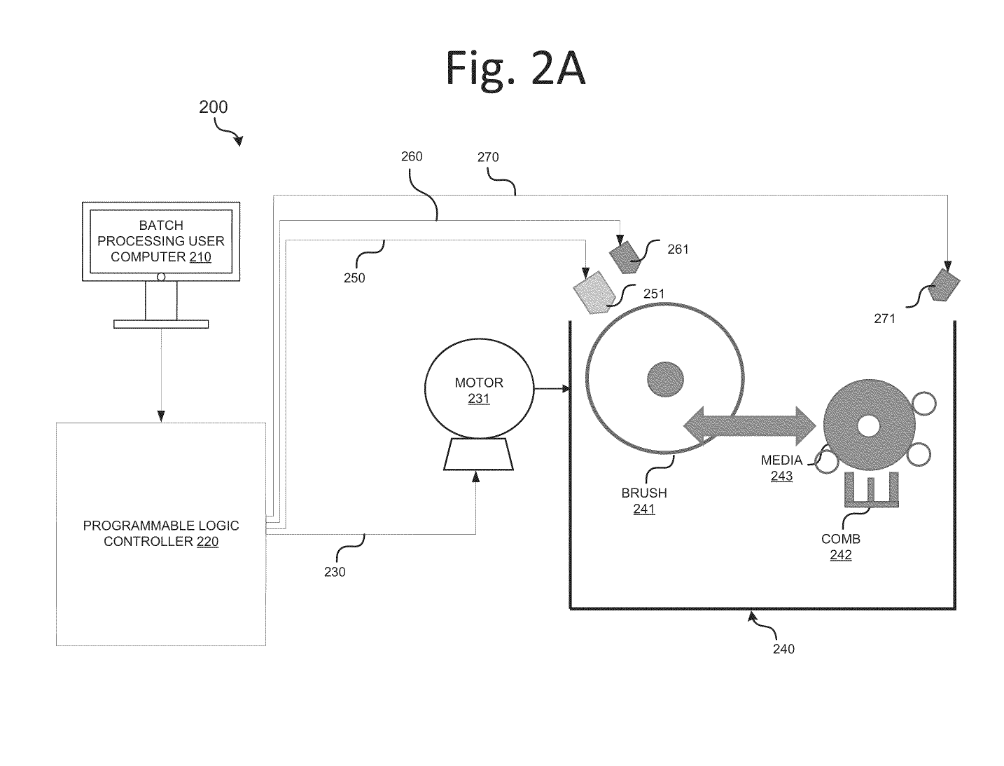

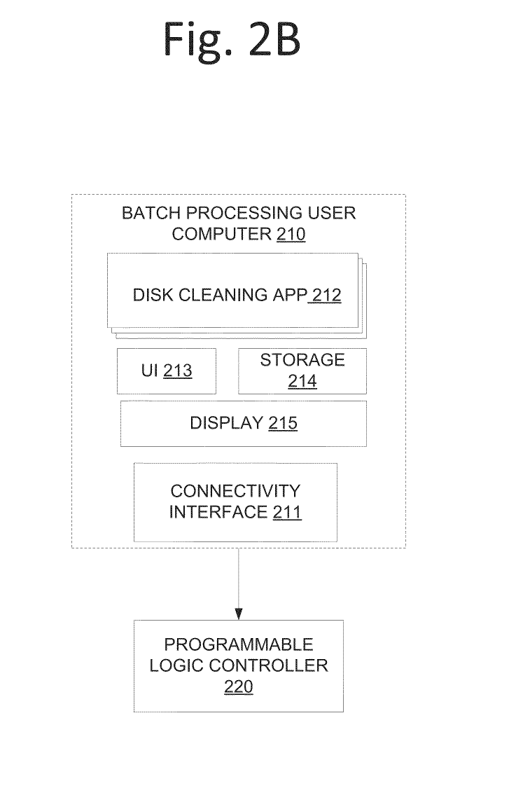

FIG. 2A is a schematic diagram of an exemplary programmable batch scrubber system 200 in accordance with an embodiment of the present disclosure. As illustrated in this embodiment, batch scrubber system 200 comprises a batch processing user computer 210, programmable logic controller (PLC) 220, a motor 231, and batch scrubber process tank (batch scrubber) 240. Batch scrubber 240 includes, brushes 241, combs 242, deionized water dispensers 261 and 271, and cleaning solution dispenser 251. In some embodiments, motor 231 is integrated into batch scrubber 240.

In the illustrated system, batch scrubber 240 utilizes a plurality of brushes 241 to scrub multiple polished magnetic media 243 simultaneously, thereby removing contamination particles from the surface of the media. Each brush 241 may comprise a porous material for absorbing fluid such as PVA, PU, expanded PTFE, etc. Brushes 241 are driven by motor 231 and rotated in a direction such that the brushes engage the surfaces of plated media 243. For example, in one embodiment each brush 241 is double sided and positioned between two adjacent plated media 243.

Combs 242 are configured to support a plurality of plated media 243 in an arrangement that keeps the media separated from one another such that media 243 may be scrubbed by multiple brushes 241. In some embodiments, combs 242 are further configured to allow plated media 243 to rotate when they are engaged by a rotating brush. Consider as an example, the embodiment where each brush is double sided and positioned between two adjacent plated media 243. In this example embodiment, combs 242 may be uniformly separated and aligned along a common axis. In implementations of this embodiment, when a rotating brush 241 engages media 243 supported by comb 242, the rotation of the disk may rotate the disk along the common axis during cleaning. In other embodiments, other configurations of brushes 241 and combs 242 may be used.

During various cleaning operations, dispenser 251 dispenses a cleaning solution and dispensers 261 and 271 dispense deionized water in various portions of the batch scrubber 240. Each of dispensers 251, 261, and 271, may be coupled to a respective fluid delivery system that includes a reservoir for the deionized water or cleaning solution, a connection from the reservoir to the dispenser, and a pump for delivering the deionized water or cleaning solution along the connection. In some embodiments, the cleaning solution and/or deionized water may be dispensed using a sprayer. In further embodiments, cleaning solution dispenser 251 may comprise a flow sensor for regulating the volume of cleaning solution that is dispensed from the reservoir. In yet further embodiments, each of dispensers 251, 261, and 271 may comprise a manual valve for manually disabling or enabling fluid flow in the dispenser.

In the illustrated batch scrubber 240, dispenser 251 dispenses the cleaning solution on brushes 241, dispenser 261 dispenses deionized water on brushes 241 to keep them moist and free of contaminants, and dispenser 271 dispenses deionized water on media 243 to keep them moist when engaged by brush 241. In alternative embodiments, the cleaning solution and deionized water may be dispensed in different portions of the batch scrubber 240. For example, in one embodiment, batch scrubber may further comprise additional deionized water dispensers configured to dispense deionized water on the lower interior of batch scrubber 240 and/or comb 242 to rinse away any buildup of cleaning solution or removed contaminant. As another example, the cleaning solution may be dispensed on media 243.

In various embodiments, batch scrubber 240 cleans the disk media 243 in a plurality of configurable cleaning steps, each of the cleaning steps comprising a predetermined cleaning duration, cleaning speed (RPM) of brushes 241, and dispensing states (ON or OFF) of dispensers 251, 261, and 271. Additionally, each cleaning step may further consider the cleaning solution volume as a parameter. In these embodiments a user operating batch processing user computer 210 configures the number of cleaning steps, the available parameters for each cleaning step (e.g. time, dispenser 1, dispenser 2, etc.), and parameter values for each cleaning step (e.g. brush speed, dispenser states, duration, cleaning solution volume, etc.). As illustrated in system 200, batch processing computer user 210 is coupled to PLC 220, which provides a plurality of respective analog and/or digital output lines 230, 250, 260, and 270 to motor 231 and dispensers 251, 261, and 271. More particularly, PLC 220 may provide an output line 230 to a motor driver (e.g. transistorized inverter) of motor 231 that automatically controls the RPM of brushes 241. Output lines 250, 260, and 270 may couple to an automatic valve (not shown) of dispensers 251, 261, and 271, each automatic valve controlling the respective dispensing state (ON or OFF) of each dispenser. In further embodiments, output line 250 may be used to regulate the volume of cleaning solution dispensed during each cleaning step.

FIG. 2B is a high-level block diagram illustrating an example batch processing user computer 210 that may be used to provide a configurable batch scrubbing method in accordance with an embodiment. Batch processing user computer may be any hand-held computing device (tablets, smartphones, hybrid, etc.), workstation or any other type of computing device configured to run a disk cleaning application and communicate with PLC 220. As illustrated, batch processing computer 210 may comprise a connectivity interface 211, a media disk cleaning application 212, a user interface 213, a storage 214 and display 215. User interface 213 may be configured to allow user input into disk cleaning application 214 for display on a display 215. Connectivity interface 211 provides a wired or wireless communications link with programmable logic controller 220 and may be used to communicate information such as voltage outputs and duration for each output line based on parameters entered into media disk cleaning application 212. In some embodiments, PLC 220 may be integrated with computer 210.

Media disk cleaning application 212 is provided to a user of computer 210 via user interface 213 and allows a user to configure the number of batch processing cleaning steps, the parameters for each cleaning step, and the values of each parameter. For example, application 212 may provide various modules for controlling the number of cleaning steps and value of parameters for a batch process such as the duration of each cleaning step, the brush RPM for each cleaning step, and the dispensing state (ON/OFF) of each dispenser for each cleaning step. Furthermore, application 212 may additionally provide modules for controlling the parameters considered in a cleaning step (e.g. number of dispensers) to account for possible changes in batch scrubber 240 (e.g. changes in the number of dispensers). In one embodiment, the number of available parameters is determined based on the number of detected outputs for PLC 220.

Table 2, below, illustrates the configurable batch process cleaning steps and parameters of system 200 and may be adapted to include additional parameters (e.g. additional dispensers).

TABLE 2
Disclosed Batch Scrubbing Method

| | | | Cleaning | DI | DI |
|---|---|---|---|---|---|
| STEP | BRUSH | | Dispenser | 1 Dispenser | 2 Dispenser |
| NO. | RPM | DURATION | State | State | State |
| Step 1 | RPM₁ | T₁ | ON/OFF | ON/OFF | ON/OFF |
| Step 2 | RPM₂ | T₂ | ON/OFF | ON/OFF | ON/OFF |
| . . . | . . . | . . . | . . . | . . . | . . . |
| Step N | RPM_{N} | T_{N} | ON/OFF | ON/OFF | ON/OFF |

In some embodiments, one or more batch processing cleaning profiles associated with a number of cleaning steps, parameters, and parameter values may be saved in storage 214 for later use. The disclosed configurability of batch processing system 200 provides the benefit of easily adapting system 200 to changes in the process conditions of batch scrubber 240.

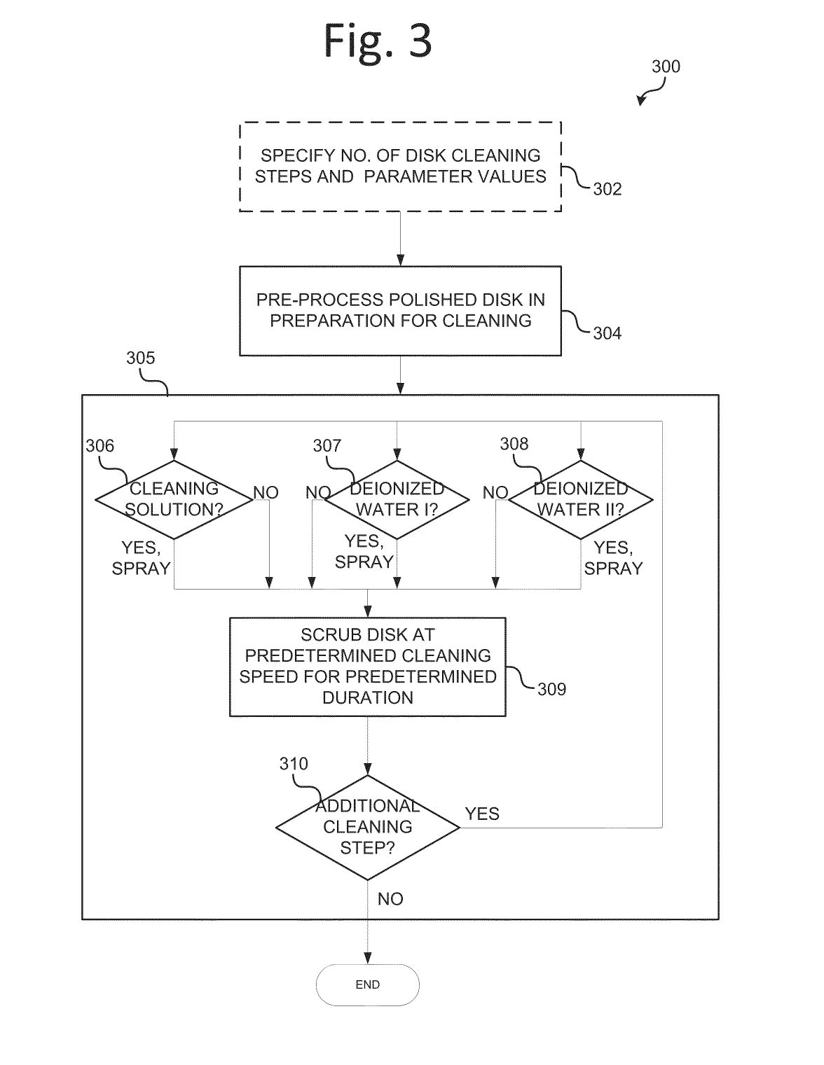

System 200 will now be described with respect to FIG. 3, which is an operational flow diagram illustrating an exemplary method 300 for cleaning one or more polished magnetic media disks 243. At operation 301 a user may specify a number of disk cleaning steps and parameter values (e.g. brush RPM at each step, dispensing state for each dispenser at each step, time for each step, etc.) In further embodiments, a user may also specify the disk cleaning parameters at operation 302. For example, in one embodiment a plurality of different disk cleaning speeds (RPM) may be specified for a plurality of disk cleaning steps. In one particular implementation of this embodiment, the total cleaning time specified for each step is less than 15 seconds and the total cleaning duration for a batch cleaning process is less than 45 seconds.

In alternative embodiments, the desired disk cleaning steps and parameter values may have already been set (e.g. they have been specified in a prior batch cleaning or are loaded from a batch processing cleaning profile). In these embodiments, operation 302 may be skipped.

At operation 304, the polished magnetic media disks may be pre-processed in preparation for cleaning using a batch cleaning process 305. In one embodiment, this pre-processing step includes soaking the plated disks 243 in an ultrasonic tank comprising deionized water and, optionally, a cleaning solution. The liquid in the tank may be agitated to remove contamination particles from the surface of plated disks 243. In further embodiments, additional pre-processing tools may be used to remove particles from the surface of media 243 prior to cleaning the media in the batch scrubber. The magnetic media disks are then loaded into combs 242 in preparation for a batch scrubbing process 305.

At operation 305, batch scrubber 240 applies a batch scrubbing process based on the predetermined disk cleaning steps and parameter values. FIG. 3 illustrates an example operation flow for a batch scrubbing process 305 that may be implemented with the batch scrubber 240 of system 200. At decisions 306-308, the respective dispensing states (ON/OFF) of cleaning solution dispenser 251, deionized water dispenser 261, and deionized water dispenser 271 are determined for a particular cleaning step. Depending on the dispensing states, none, some, or all of the dispensers may be activated or deactivated during the cleaning step. At operation 309, the disk is scrubbed at the step's predetermined brush cleaning RPM for a predetermined duration. At decision 310, if there are additional cleaning steps, process 305 is repeated based on the predetermined parameter values for the next cleaning step.

In one embodiment of batch scrubbing process 305, the transition between cleaning steps is seamless. That is, once the duration for a particular cleaning step runs out, dispensers 251, 261, and 271 are automatically turned ON/OFF and the brush RPM is automatically set. In this seamless embodiment, brushes 241 may change RPM without disengaging media 243.

In one particular embodiment for a first cleaning step, the brush speed is 10 to 50 RPM, the scrub time is 2 to 20 seconds, dispenser 261 is turned off, dispenser 271 dispenses deionized water, and dispenser 251 dispenses cleaning solution. In another particular embodiment for an intermediate step, the brush speed is 20 to 60 RPM, the scrub time is 2 to 20 seconds, deionized water dispensers 261 and 271 are turned off, and cleaning solution dispenser 251 dispenses cleaning solution.

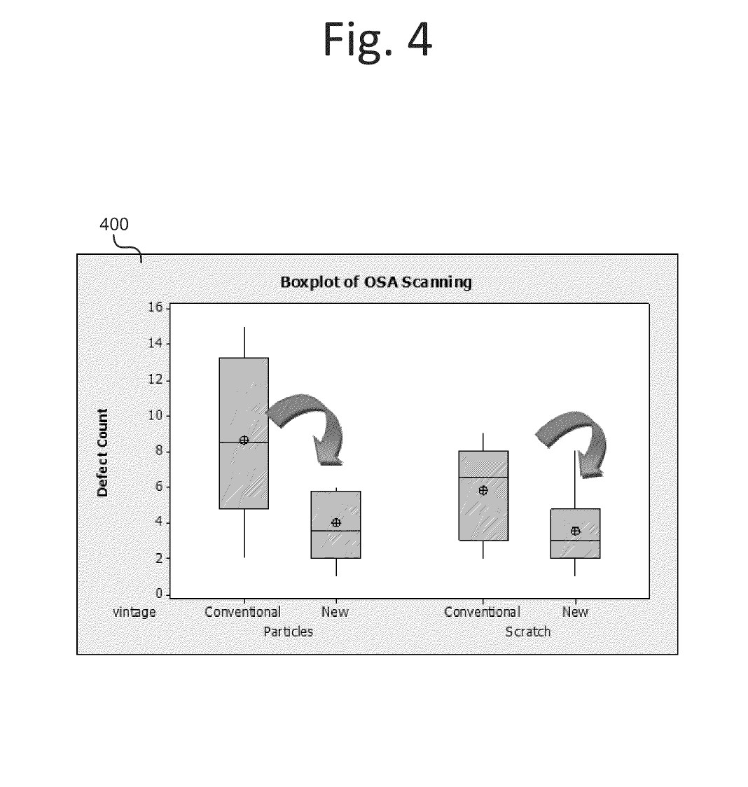

FIG. 4 is a chart 400 illustrating differences in cleaned disk defect counts between conventional batch scrubber systems and the batch scrubber systems disclosed herein. As illustrated by chart 400, the disclosed system and method on average removed more contamination particles and produced fewer scratches on the media surface during cleaning. Additionally, the disclosed system improved the batch process efficiency by increasing the particle removable rate.

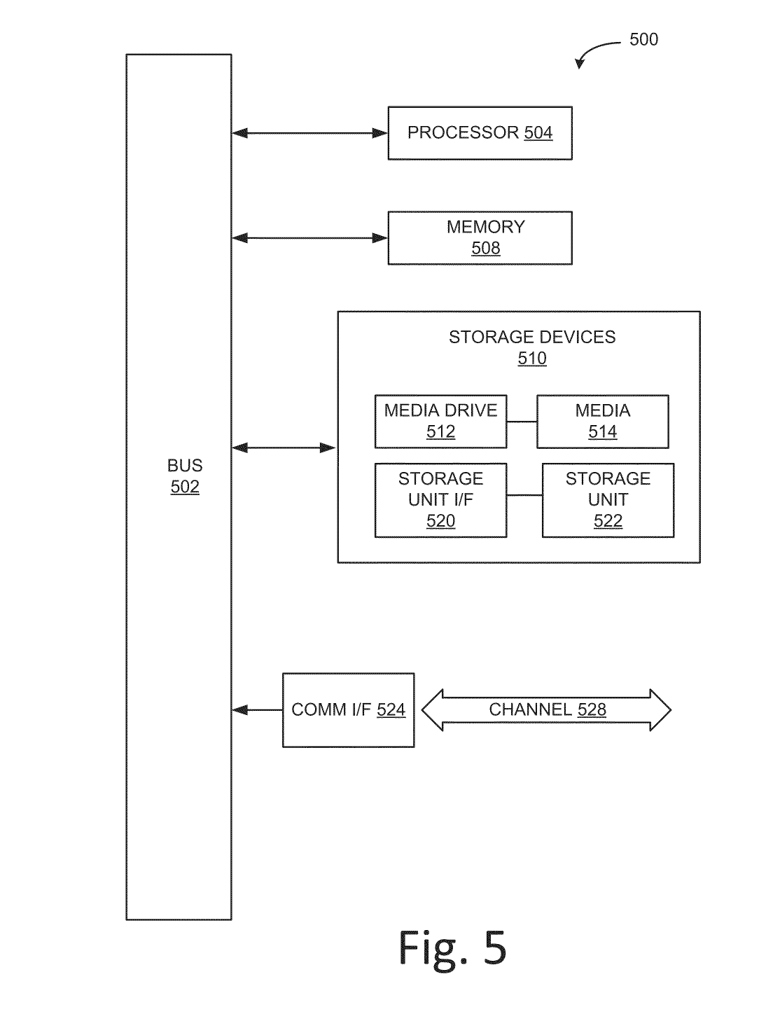

FIG. 5 illustrates an example computing module that may be used to implement various features of the methods disclosed herein.

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 5. Various embodiments are described in terms of this example-computing module 500. After reading this description, it will become apparent to a person skilled in the relevant art how to implement the application using other computing modules or architectures.

Referring now to FIG. 5, computing module 500 may represent, for example, computing or processing capabilities found within desktop, laptop, notebook, and tablet computers; hand-held computing devices (tablets, PDA's, smart phones, cell phones, palmtops, etc.); mainframes, supercomputers, workstations or servers; or any other type of special-purpose or general-purpose computing devices as may be desirable or appropriate for a given application or environment. Computing module 500 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 500 might include, for example, one or more processors, controllers, control modules, or other processing devices, such as a processor 504. Processor 504 might be implemented using a general-purpose or special-purpose processing engine such as, for example, a microprocessor, controller, or other control logic. In the illustrated example, processor 504 is connected to a bus 502, although any communication medium can be used to facilitate interaction with other components of computing module 500 or to communicate externally.

Computing module 500 might also include one or more memory modules, simply referred to herein as main memory 508. For example, preferably random access memory (RAM) or other dynamic memory, might be used for storing information and instructions to be executed by processor 504. Main memory 508 might also be used for storing temporary variables or other intermediate information during execution of instructions to be executed by processor 504. Computing module 500 might likewise include a read only memory (“ROM”) or other static storage device coupled to bus 502 for storing static information and instructions for processor 504.

The computing module 500 might also include one or more various forms of information storage mechanism 510, which might include, for example, a media drive 512 and a storage unit interface 520. The media drive 512 might include a drive or other mechanism to support fixed or removable storage media 514. For example, a hard disk drive, a solid state drive, a magnetic tape drive, an optical disk drive, a CD or DVD drive (R or RW), or other removable or fixed media drive might be provided. Accordingly, storage media 514 might include, for example, a hard disk, a solid state drive, magnetic tape, cartridge, optical disk, a CD or DVD, or other fixed or removable medium that is read by, written to or accessed by media drive 512. As these examples illustrate, the storage media 514 can include a computer usable storage medium having stored therein computer software or data.

In alternative embodiments, information storage mechanism 510 might include other similar instrumentalities for allowing computer programs or other instructions or data to be loaded into computing module 500. Such instrumentalities might include, for example, a fixed or removable storage unit 522 and an interface 520. Examples of such storage units 522 and interfaces 520 can include a program cartridge and cartridge interface, a removable memory (for example, a flash memory or other removable memory module) and memory slot, a PCMCIA slot and card, and other fixed or removable storage units 522 and interfaces 520 that allow software and data to be transferred from the storage unit 522 to computing module 500.

Computing module 500 might also include a communications interface 524. Communications interface 524 might be used to allow software and data to be transferred between computing module 500 and external devices. Examples of communications interface 524 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 524 might typically be carried on signals, which can be electronic, electromagnetic (which includes optical) or other signals capable of being exchanged by a given communications interface 524. These signals might be provided to communications interface 524 via a channel 528. This channel 528 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 508, storage unit 520, media 514, and channel 528. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 500 to perform features or functions of the present application as discussed herein.

In the foregoing specification, embodiments of the disclosure have been described with reference to specific exemplary features thereof. It will, however, be evident that various modifications and changes may be made thereto without departing from the broader spirit and scope of the disclosure. The specification and figures are, accordingly, to be regarded in an illustrative rather than a restrictive sense.

What is claimed is:

1. A batch scrubber system for cleaning a polished magnetic media disk, comprising:
a non-transitory computer readable medium having computer executable program code embodied thereon, the computer executable program code configured to cause a computing device to specify a plurality of brush scrubbing speeds for a batch cleaning process; and
a batch scrubber comprising:
a brush configured to scrub the disk at the plurality of speeds during cleaning of the disk;
a combing system configured to support the disk during cleaning;
a cleaning solution dispenser; and
a first deionized water dispenser configured to dispense water on the brush during cleaning.

2. The batch scrubber system of claim 1, wherein the computer executable program code is further configured to cause a computing device to specify a plurality of cleaning steps, each of the cleaning steps comprising predetermined parameter values including a cleaning duration and a cleaning speed of the brush, and wherein the disk is cleaned in the plurality of cleaning steps.

3. The batch scrubber system of claim 2, wherein each of the cleaning steps comprises a predetermined dispensing state of the cleaning solution dispenser.

4. The batch scrubber system of claim 3, wherein each of the cleaning steps comprises a predetermined dispensing state of the first deionized water dispenser.

5. The batch scrubber system of claim 4, wherein there are at least three cleaning steps.

6. The batch scrubber system of claim 5, wherein each of the cleaning steps comprises a unique combination of cleaning duration, cleaning speed, dispensing state of the cleaning solution dispenser, and dispensing state of the first deionized water dispenser.

7. The batch scrubber system of claim 6, wherein each of the cleaning steps comprises a unique combination of cleaning duration and cleaning speed.

8. The batch scrubber system of claim 5, the batch scrubber further comprising a second deionized water dispenser configured to dispense water on the disk during cleaning, and wherein each of the cleaning steps comprises a dispensing state of the second deionized water dispenser.

9. The batch scrubber system of claim 6, wherein there are at least four cleaning steps.

10. The batch scrubber system of claim 6, the batch scrubber further comprising a plurality of brushes configured to brush a plurality of disks supported by a plurality of combs, wherein each of the cleaning steps comprises a cleaning duration and a cleaning speed for the plurality of brushes.

11. A method for cleaning a polished magnetic media disk in a batch scrubber system, comprising:
mounting the disk on a combing system;
cleaning the disk at a plurality of predetermined cleaning speeds using a brush;
dispensing cleaning solution dispenser; and
dispensing water on the brush using a first deionized water dispenser.

12. The method of claim 11, wherein the disk is cleaned in a plurality of cleaning steps, each of the cleaning steps comprising predetermined parameter values including a cleaning duration and a cleaning speed of the brush.

13. The method of claim 12, wherein each of the cleaning steps comprises a predetermined dispensing state of the cleaning solution dispenser.

14. The method of claim 13, wherein each of the cleaning steps comprises a predetermined dispensing state of the first deionized water dispenser.

15. The method of claim 14, wherein there are at least three cleaning steps.

16. The method of claim 15, wherein each of the cleaning steps comprises a unique combination of cleaning duration, cleaning speed, dispensing state of the cleaning solution dispenser, and dispensing state of the first deionized water dispenser.

17. The method of claim 16, wherein each of the cleaning steps comprises a unique combination of cleaning duration and cleaning speed.

18. The method of claim 15, further comprising a second deionized water dispenser configured to dispense water on the disk during cleaning, and wherein each of the cleaning steps comprises a dispensing state of the second deionized water dispenser.

19. The method of claim 16, wherein there are at least four cleaning steps.

20. The method of claim 16, further comprising a plurality of brushes configured to brush a plurality of disks supported by a plurality of combs, wherein each of the cleaning steps comprising a cleaning duration and a cleaning speed for the plurality of brushes.
